(19) United States
(12) Patent Application Publication
(10) Pub. No.: US 2010/0138752 A1
(43) Pub. Date: Jun. 3, 2010

(54) Usage Of Flash Variables As Import Parameter For A Dashboard In A Portal Environment

(76) Inventors: Carina Schneider, Mannheim (DE); Matthias De la Roche, Meulussheim (DE); Anand Sinha, Bangalore (IN)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/326,827

(22) Filed: Dec. 2, 2008

(51) Int. Cl. G06F 3/048

(52) U.S. Cl. 715/742

(57) ABSTRACT

Systems and method for using flash variables as import parameters for a dashboard in a portal environment are presented. One or more values that define a portal environment that displays a graphical dashboard are determined. The dashboard is adapted to display in the portal environment graphical representations of data from a data source connected with a backend system. A flash object is generated for retrieving selected data from the data source connected with the backend system based on a request for the data from the dashboard, and for generating the graphical representations for the dashboard. One or more flash variables corresponding to the one or more values are generated, the one or more flash variables defining the selected data of the data source to be retrieved based on the one or more values. The one or more flash variables are inserted into the flash object for retrieving the selected data from the data source.

### BACKGROUND

This disclosure relates generally to a visualization tool for a dashboard in a portal environment, and more particularly to the use of flash variables as an import parameter for data to be represented in the dashboard.

For businesses to provide immediate access to key business information, they seek customized solutions for knowledge workers that consolidate personal, team, corporate, and external information, and provide rapid access to graphical analytical and collaborative tools. These solutions bring an integrated view of a company's knowledge sources to an individual's desktop, enabling better decision making by displaying information from diverse sources in a unified way.

One such solution is the corporate portal—a webpage or website that provides a common, consolidated informative function via access or links to other websites. Portals often function as a point of access to company-related information on corporate servers or the World Wide Web. Apart from the search engine standard, web portals offer other services such as e-mail, news, analytical tools and web services. Corporate portals provide a way for enterprises to provide a consistent visualization and operation by enterprise users, with access control and procedures for multiple applications.

One of the most useful tools within a portal environment, besides the portal itself, is a concept known as a dashboard. The term dashboard generally refers to a web-based technology page on which real time information is collated from various sources in the business. Data visualization tools, such as the Xcelsius tools developed by Business Objects, a unit of SAP A.G. of Walldorf, Germany, enable users of different skill levels to transform complex business data from any data source into actionable visual information to create insightful and engaging dashboards. For example, some visualization tools take ranges of numbers in a spreadsheet and connect them to visual graphical objects like buttons, dials, levers, gauges and charts, for display to a user in a dashboard. Then the users can interact with the data by clicking on buttons, sliding levers and turning dials. They see the impact of their interactions with the data in real time.

Some visualization tools like Xcelsius generate interactive visualizations that can use web services. However, the web service host address is defined at development time. A way is needed to pass a dynamic host address to the web service. Also, some data visualization tools can generate a graphical animation file, such as a multimedia flash file. A way is needed to integrate such animation files into a portal environment. Further, conventional data visualization tools lack an ability to generate dashboards for multiple languages, and hence, lack localization capability without significant reconfiguration.

### SUMMARY

In general, this document discusses a system and method for using flash variables as an import parameter for data to be represented in a dashboard.

In one aspect, a method is disclosed. The method includes the step of determining one or more values that define a portal environment that displays a graphical dashboard. The dashboard is adapted to display in the portal environment graphical representations of data from a data source connected with a backend system. The method further includes the step of generating a flash object for retrieving selected data from the data source connected with the backend system based on a request for the data from the dashboard, and for generating the graphical representations for the dashboard. The method further includes the steps of generating one or more flash variables corresponding to the one or more values, the one or more flash variables defining the selected data of the data source to be retrieved based on the one or more values, and inserting the one or more flash variables into the flash object for retrieving the selected data from the data source.

In another aspect, a system is presented. The system includes a portal environment that displays a graphical dashboard, the dashboard being adapted to display in the portal environment graphical representations of data from a data source connected with a backend system. The system further includes a data visualization tool connected with the portal environment and adapted to determine one or more values that define the portal environment, generate a flash object for retrieving selected data from the data source, and generate one or more flash variables corresponding to the one or more values. The one or more flash variables define the selected data of the data source to be retrieved based on the one or more values. The data visualization tool is further adapted to insert the one or more flash variables into the flash object for retrieving the selected data from the data source.

In yet another aspect, a system includes means for determining one or more values that define a portal environment that displays a graphical dashboard, the dashboard being adapted to display in the portal environment graphical representations of data from a data source connected with a backend system. The system further includes means for generating a flash object for retrieving selected data from the data source connected with the backend system based on a request for the data from the dashboard, and for generating the graphical representations for the dashboard. The system further includes means for generating one or more flash variables corresponding to the one or more values, the one or more flash variables defining the selected data of the data source to be retrieved based on the one or more values, and means for inserting the one or more flash variables into the flash object for retrieving the selected data from the data source.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a system for using flash variables as an import parameter for data to be graphically represented in a dashboard of a portal.

FIG. 2 is a flowchart of a method for using flash variables as an import parameter.

FIGS. 3-7 illustrate various steps shown in FIG. 2.

Like reference symbols in the various drawings indicate like elements.

### DETAILED DESCRIPTION

This document describes a system and method using flash variables as an import parameter for data to be represented in a dashboard.

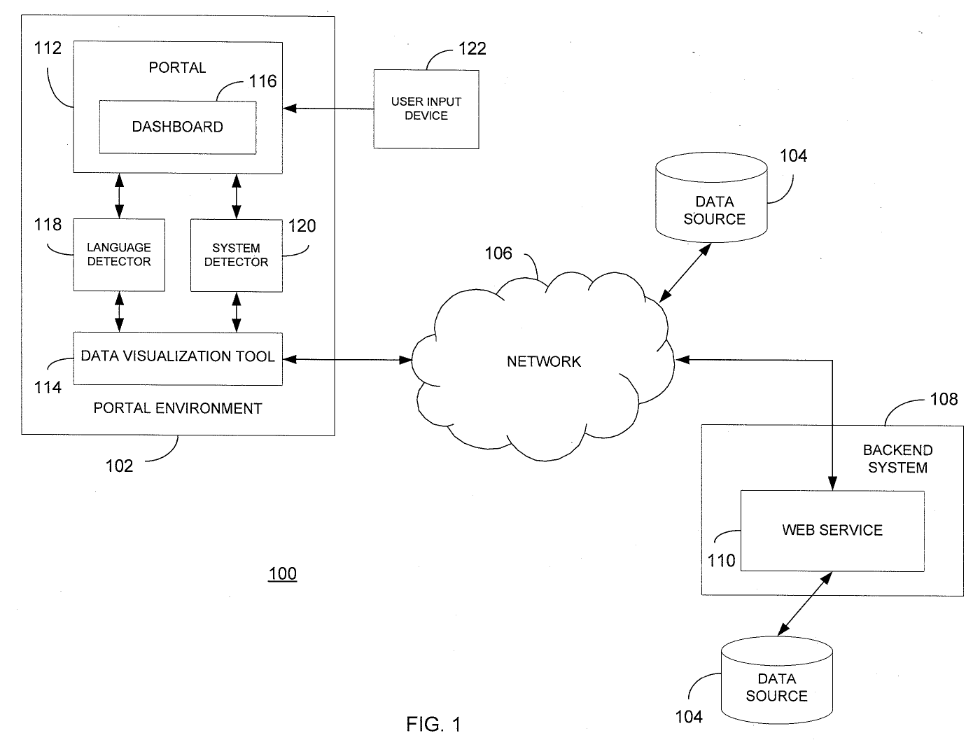

FIG. 1 shows a system 100 in which a portal environment 102 receives data from one or more data sources 104 via a network 106. The network 106 can be any type of network, such as the Internet or “World Wide Web,” corporate intranet, or any other type of computer data network. The one or more data sources 104 can be implemented as standalone databases, connected with a server computer, or may be part of a backend system 108 such as a server, group of servers, a database management system, or other type of backend system. The backend system 108 may employ one or more web services 110 for accessing and delivering requested data to the portal environment 102. The portal environment 102 can include a client computing system such as a desktop computer, laptop computer, or handheld computer, and includes a display.

The display displays a portal 112. The portal 112 may be a web page or website as a common interface to enterprise-related information and data. As such, the portal 112 can include a number of graphical and textual elements. The portal 112 and its functional components are accessible and controllable by a user. The user can send commands, requests, queries or other inputs to the portal via a user input device 122. The user input device can be a mouse or a keyboard, or any other user input device, and the inputs can include a log-on that allows the user to access the portal. The log-on can be in the form of a character string, and usually is in the form of text related to a particular language. The portal 112 and its functional components are provided according to one of many types of languages and/or systems, meaning that any number of systems can generate a portal 112 in a computer code language suitable to display the portal 112 in a display.

The portal environment 102 further includes a data visualization tool 114 that transforms data from any of the one or more data sources 104 into actionable visual information for display in a dashboard 116 that is rendered and displayed with or within the portal 112. The dashboard 116 presents visual graphical objects like graphs, buttons, dials, levers, gauges and charts, for display to a user. Some of the visual graphical objects are interactive, such that the users can interact with the data by clicking on buttons, sliding levers and turning dials, and manipulate and interact with the data in real time.

Within the portal environment 102, a language detector 118 detects and determines a user's log-on language. The language detector 118 may be implemented as a software code module, and preferably as JavaServer Pages (JSP), and utilizes flash variables to represent the determined language. The language detector 118 generates a first flash variable representing the determined language, and the determined language is passed, via the first flash variable, to the data visualization tool 114. In some specific implementations, the data visualization tool 114 uses data from a data source 104 from a backend system 108, and calls the webservice 110 that is delivering text data. The data visualization tool 114 passes the first flash variable to the backend system 108 for retrieval of the text in the correct language, i.e. the language that matches the detected language from the language detector 118.

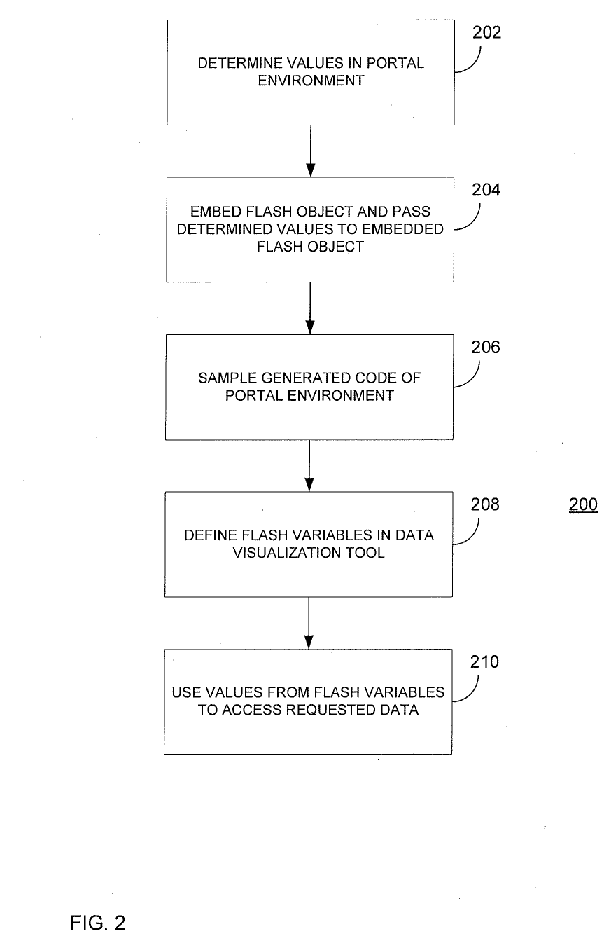

Also within the portal environment 102, a system detector 120 detects and determines which system is running in the portal environment, i.e. which code, platform, operating system, etc., on which the portal 112 and its functional components run. The system detector 120 may preferably be implemented as a software code module such as a JSP. For systems using the backend system 108, the system detector 120 dynamically builds a uniform resource locator (URL) to the backend 108, and generates a second flash variable that is passed to the data visualization tool 114. The data visualization tool 114 uses the URL to call the webservice 110 in the relevant backend system 108, and retrieves the data as requested by the user. In exemplary implementations using JSP, some coding in the JSP calls the flash variables to pass all needed information via flash variable to the data visualization tool 114. These processes are described in further detail below and with reference to FIG. 2.

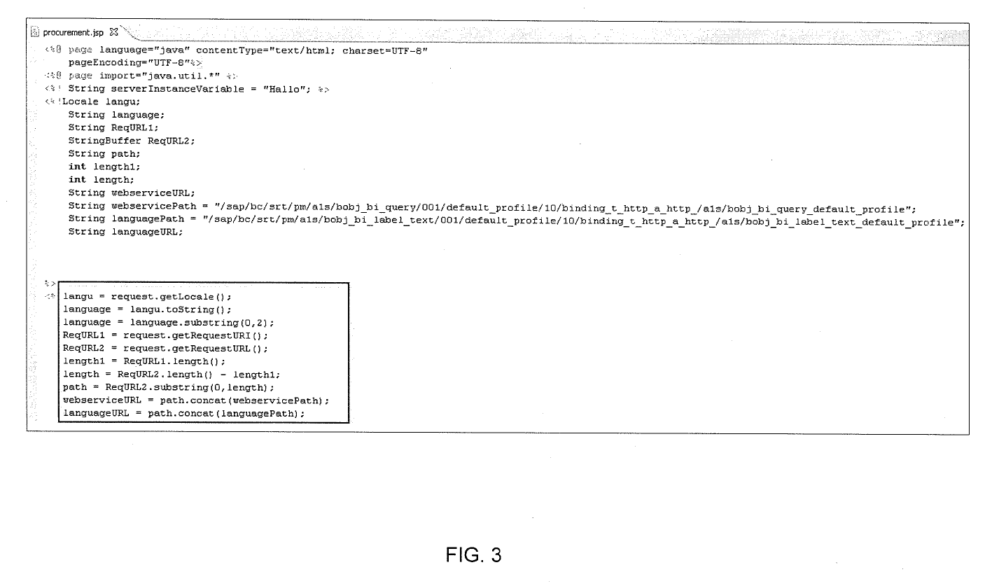

FIG. 2 is a flowchart of a method 200 for using flash variables as an import parameter for data to be represented in a dashboard. The dashboard is displayed within a portal environment, which may display a portal or other website. FIGS. 3-7 illustrate various steps shown in FIG. 2. At 202, certain values in the portal environment are determined. In preferred implementations, a JSP determines the values and passes them to a data visualization tool that transforms requested data into actionable graphical representations in the dashboard. As shown in FIG. 3, the values may be the language used by a user, from log-on or other information. The values may also include host and port values for the URLs of the location of requested data.

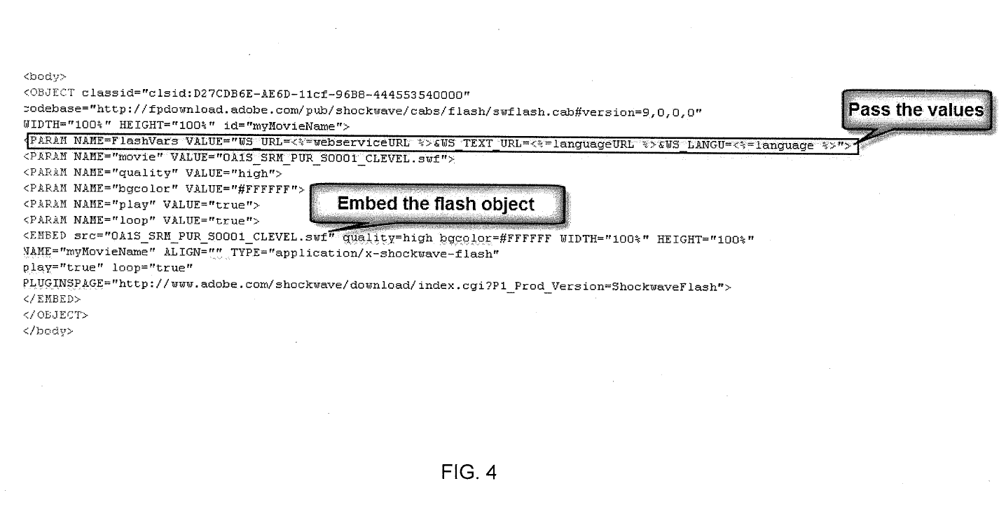

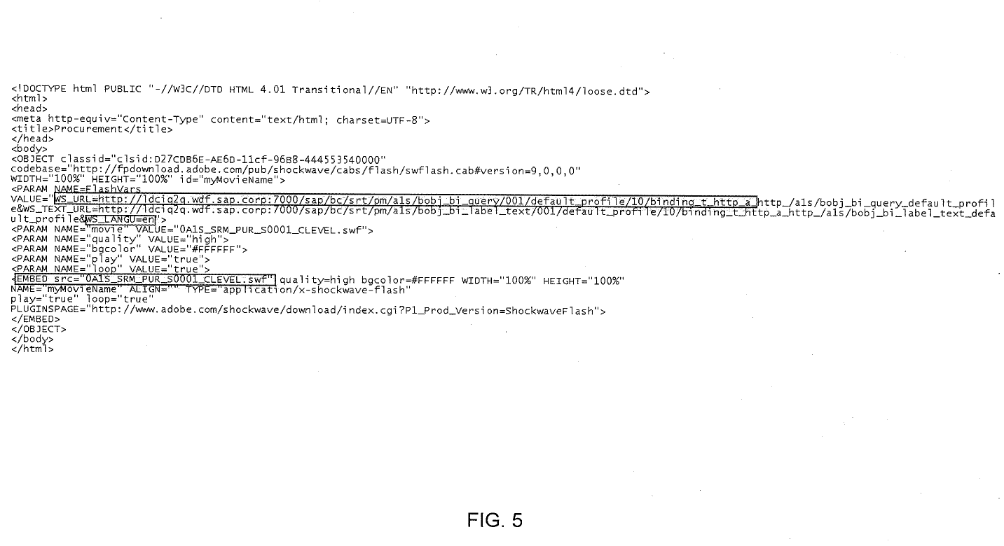

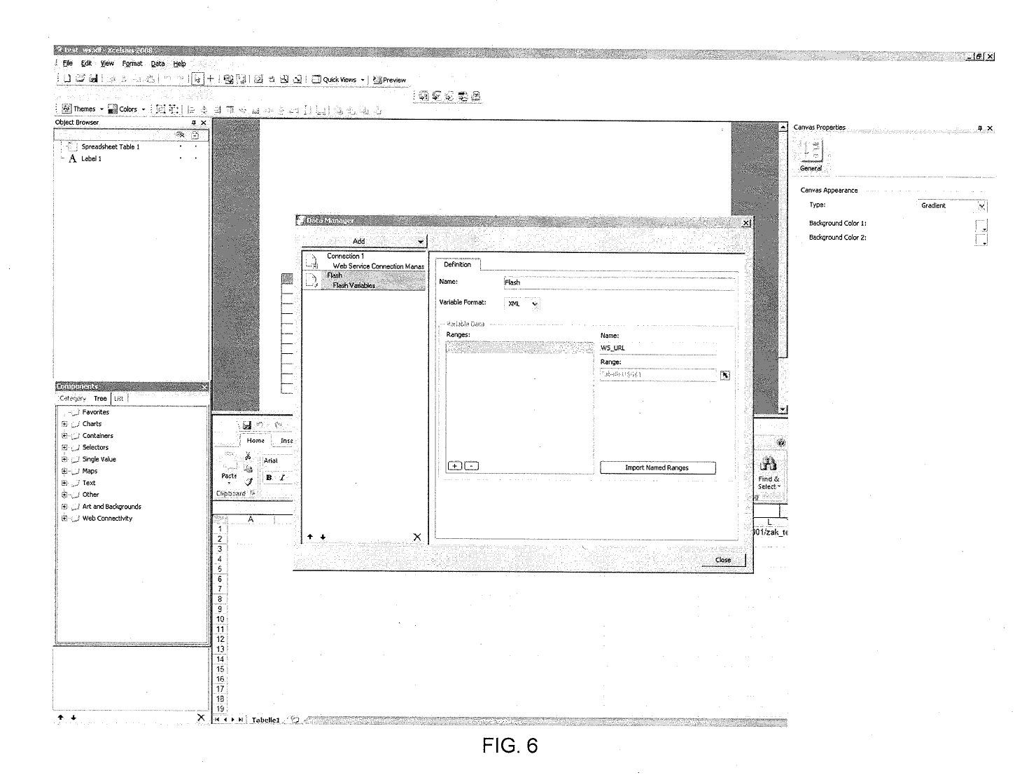

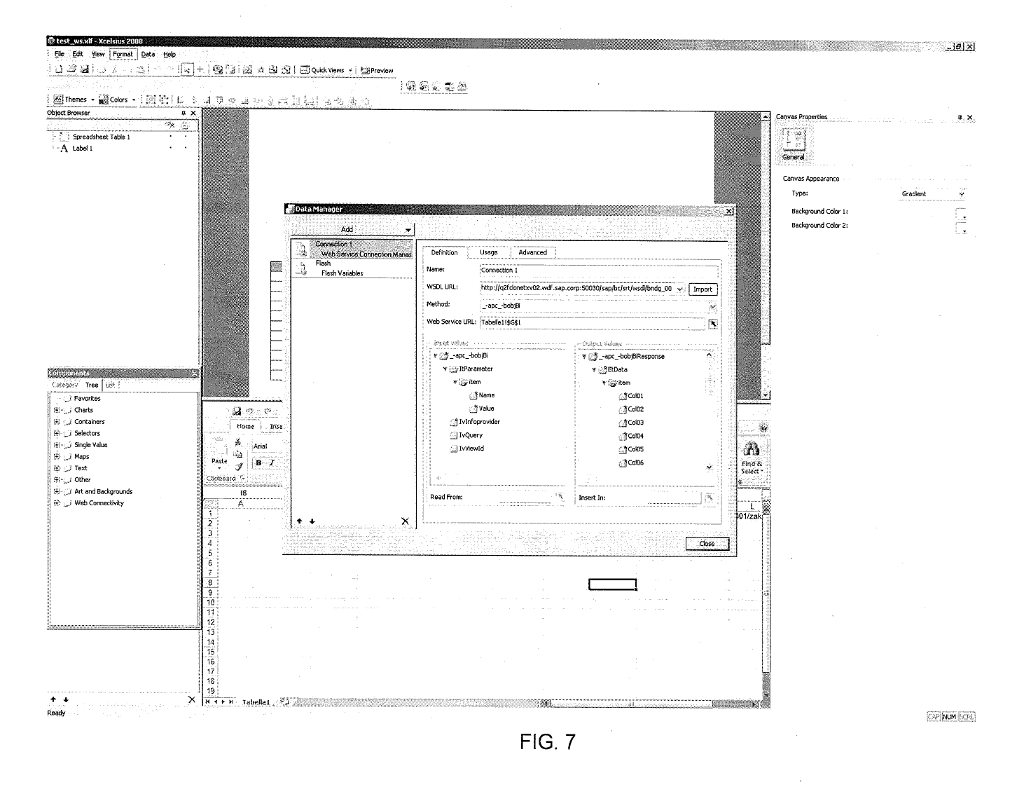

At 204, a flash object is embedded in the data visualization tool, and the JSP passes the determined values to the flash object in the data visualization tool, as illustrated in FIG. 4. At 206, the generated code is sampled, including the correct links as represented by requested URLs, and the language, for being sent to the data visualization tool. FIG. 5 illustrates exemplary code to accomplish step 206. At 208, flash variables are defined in the data visualization tool, as shown in FIG. 6, which illustrates the same name as in the JSP coding, and a mapping of the input value to cell “G1” as an example. Next, at 210, the flash variables are used to access the requested data, such that the correct data is accessed and obtained. FIG. 7 illustrates one example in which the webservice URL stored in the cell “G1” is defined by mapping the content of the cell “G1” to the URL. Those having skill in the art would recognize that FIGS. 3-7 are merely illustrative of but one example implementation, and that other implementations are possible and enabled by the disclosure herein.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A method comprising:
determining one or more values that define a portal environment that displays a graphical dashboard, the dashboard being adapted to display in the portal environment graphical representations of data from a data source connected with a backend system;
generating a flash object for retrieving selected data from the data source connected with the backend system based on a request for the data from the dashboard, and for generating the graphical representations for the dashboard;
generating one or more flash variables corresponding to the one or more values, the one or more flash variables defining the selected data of the data source to be retrieved based on the one or more values; and
inserting the one or more flash variables into the flash object for retrieving the selected data from the data source.

2. The method in accordance with claim 1, wherein the one or more values includes a language value that designates a language of the selected data.

3. The method in accordance with claim 2, wherein the language value is determined from log-on information by a user input.

4. The method in accordance with claim 1, wherein the one or more values includes a URL value that designates a URL of a location of the selected data in the backend system.

5. The method in accordance with claim 4, wherein the URL value further defines a webservice associated with the selected data.

6. The method in accordance with claim 1, further comprising retrieving the selected data from the data source based on one or more flash variables.

7. The method in accordance with claim 6, further comprising generating a graphical representation of the retrieved selected data.

8. The method in accordance with claim 7, further comprising displaying the graphical representation of the retrieved selected data in the dashboard.

9. A system comprising:
a portal environment that displays a graphical dashboard, the dashboard being adapted to display in the portal environment graphical representations of data from a data source connected with a backend system;
a data visualization tool connected with the portal environment and adapted to determine one or more values that define the portal environment, generate a flash object for retrieving selected data from the data source, generate one or more flash variables corresponding to the one or more values, the one or more flash variables defining the selected data of the data source to be retrieved based on the one or more values, and insert the one or more flash variables into the flash object for retrieving the selected data from the data source.

10. The system in accordance with claim 9, wherein the data visualization tool is further adapted to retrieve the selected data from the data source based on one or more flash variables.

11. The system in accordance with claim 10, wherein the data visualization tool is further adapted to generate a graphical representation of the retrieved selected data.

12. The system in accordance with claim 11, wherein the data visualization tool is further adapted to display the graphical representation of the retrieved selected data in the dashboard.

13. The system in accordance with claim 9, further comprising a language detector connected with the data visualization tool for detecting a language value from the one or more values, the language value designating a language used by a user of the dashboard.

14. The system in accordance with claim 9, further comprising a system detector connected with the data visualization tool for detecting a system value from the one or more values, the system value designating a webservice of a backend system associated with the selected data.

15. A system comprising:
means for determining one or more values that define a portal environment that displays a graphical dashboard, the dashboard being adapted to display in the portal environment graphical representations of data from a data source connected with a backend system;
means for generating a flash object for retrieving selected data from the data source connected with the backend system based on a request for the data from the dashboard, and for generating the graphical representations for the dashboard;
means for generating one or more flash variables corresponding to the one or more values, the one or more flash variables defining the selected data of the data source to be retrieved based on the one or more values; and
means for inserting the one or more flash variables into the flash object for retrieving the selected data from the data source.

16. The system in accordance with claim 15, wherein the one or more values includes a language value that designates a language of the selected data.

17. The system in accordance with claim 16, wherein the language value is determined from log-on information by a user input.

18. The system in accordance with claim 15, wherein the one or more values includes a URL value that designates a URL of a location of the selected data in the backend system.

19. The system in accordance with claim 18, wherein the URL value further defines a webservice associated with the selected data.

20. The system in accordance with claim 15, further comprising means for retrieving the selected data from the data source based on one or more flash variables.

21. The system in accordance with claim 20, further comprising means for generating a graphical representation of the retrieved selected data.

22. The system in accordance with claim 21, further comprising means for displaying the graphical representation of the retrieved selected data in the dashboard.
